(19) United States
(12) Patent Application Publication
(10) Pub. No.: US 2006/0132606 A1
(43) Pub. Date: Jun. 22, 2006

(54) Image capture apparatus and calibrator

(75) Inventors: Tzu-Hsuan Lan, Su-Jou City (CN); Lei Chen, Su-Jou City (CN)

Correspondence Address: SNELL & WILMER;ONE ARIZONA CENTER, 400 EAST VAN BUREN, PHOENIX, AZ, 850040001, US

(73) Assignee: BENQ CORPORATION

(21) Appl. No.: 11/316,459

(22) Filed: Dec. 22, 2005

(30) Foreign Application Priority Data
Dec. 22, 2004 (TW) 93140093

(51) Int. Cl. H04N 17/00

(52) U.S. Cl. 348/187

(57) ABSTRACT

A calibration method and an image capture apparatus including a calibrator are provided. The image capture apparatus includes a window glass, an image sensor under the window glass, and a calibrator. The calibrator is disposed above the image sensor and includes a first portion and a second portion. During the calibration of the image apparatus, the image sensor scans the first portion to generate a first calibration data and scans the second portion to generate a second calibration data. Then the image sensor employs the first calibration data and the second calibration data to derive the third calibration data, which is used for the image sensor to calibrate the scan results.

### CROSS REFERENCE TO RELATED APPLICATIONS

This application claims priority to Taiwan Patent Application No. 93140093 entitled “Image Capture Apparatus and Calibrator,” filed on Dec. 22, 2004, which is incorporated herein by reference and assigned to the assignee herein.

### FIELD OF INVENTION

This invention relates to an image calibration method and an image capture apparatus using the same, and more particularly, to an image calibration method and an image capture apparatus using the same by a calibrator that completes the calibration of the image sensor in a cost effective way.

### BACKGROUND OF THE INVENTION

There are several options choosing the optical component in an image capture apparatus for different function requirements. The calibration process is an important factor to maintain the image quality.

In prior art, the calibration is implemented by having all the image sensors scan a standard white calibrator to get a standard white calibration data before scanning an object. The standard white calibration data is used to calibrate all the spatial and illuminating inaccuracy.

FIG. 1 is a schematic view of an image capture apparatus and a calibrator. As shown in FIG. 1, the image capture apparatus 100 includes a cover 101, a window glass 103, a housing 105 and a calibrator 107. Before starting to capture images, an image sensor module 109 moves to a position corresponding to the calibrator 107 for calibration. After finishing the calibration, the image sensor module 109 obtains a calibration data as a reference for the further scanning tasks.

FIG. 2 is a top view of a conventional calibrator. In prior art, a calibrator 201 is a standard color calibrator. The calibrator 201 consists completely of the standard color, for example, the standard white color. However, once some particles or dusts are accumulated on the calibrator, which usually happens in areas of low air quality, the scan quality will deteriorate seriously. Further, for coping with the scanning range of the image sensor, length of the calibrator should be greater or equal to length of the image sensor, and that is costly. Maintaining the quality and the yielding rate of the standard calibrator (for example, the standard white calibrator) with large standard-color area is yet another problem encountered during calibrator production stage.

### SUMMARY OF THE INVENTION

A calibration method and an image capture apparatus including a calibrator are provided. The image capture apparatus includes a window glass, an image sensor under the window glass, and a calibrator. The calibrator is disposed above the image sensor and includes a first portion and a second portion. During the calibration of the image apparatus, the image sensor scans the first portion to generate a first calibration data and scans the second portion to generate a second calibration data. Then the image sensor employs the first calibration data and the second calibration data to derive the third calibration data, which is used for the image sensor to calibrate the scan results.

A calibrator is also provided. The calibrator is disposed above the image sensor and includes a first portion and a second portion. During the calibration of the image apparatus, the image sensor scans the first portion to generate a first calibration data and scans the second portion to generate a second calibration data. Then the image sensor employs the first calibration data and the second calibration data to derive the third calibration data, which is used for the image sensor to calibrate the scan results.

### BRIEF DESCRIPTION OF THE DRAWINGS

FIG. 1 is a schematic view of an image capture apparatus and a calibrator.

FIG. 2 is a top view of a conventional calibrator.

FIG. 3 is a top view of an embodiment of the present invention.

FIG. 4 is a top view of another embodiment of the present invention.

FIG. 5 is a schematic view illustrating the first stage of the calibration method of the present invention.

FIG. 6 is a schematic view illustrating the second stage of the calibration method of the present invention.

### DETAILED DESCRIPTION

An image calibration method and the image capture apparatus using the same is provided. By applying the method provided herein, the cost of a calibration task is reduced effectively.

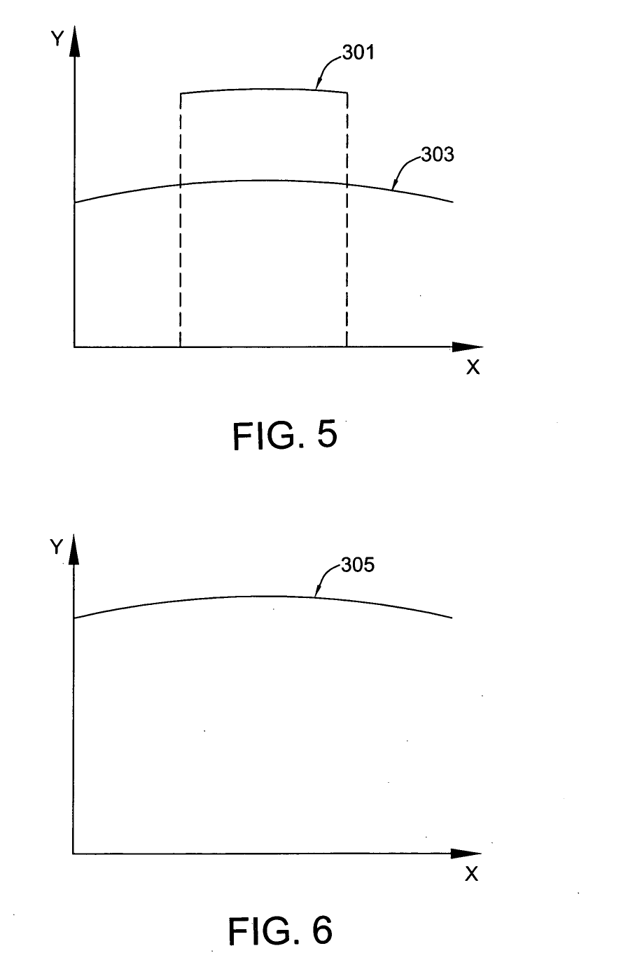

FIG. 3 is a top view of an embodiment of the present invention. The difference between the calibrator 202 of the present invention and the conventional calibrator 201 is that, the calibrator 202 includes a first portion 203 and a second portion 205, and a length of the first portion 203 is smaller than both the length of the image sensor module and the length of the second portion 205. The first portion 203 is aside of the second portion 205, and a central line of the first portion 203 substantially overlaps a central line of the second portion 205. Namely, the calibrator 202 is symmetrically disposed at its central line. The first portion 203 of the calibrator 202 has the standard color (for example, the standard white color), and the second portion 205 has any other color excepting the standard color (for example, any other color excepting the standard white color). In other embodiments, the second portion 205 can be embodied as another separated calibrator, with different color from the first portion 203. During calibration scanning, when the image sensor scans the first portion 203, the image sensor can only capture the image in the range of the first portion 203, by controlling the scanning range, to obtain the necessary data (i.e. the first calibration data described in FIG. 5; details will be described below).

FIG. 4 is a top view of another embodiment of the present invention. The calibrator 202 in this embodiment further includes two third portions 207 disposed at two sides. Disposing the two additional third portions makes the calibrator 202 a complete rectangle to facilitate production and assembling. The calibrator 202 is also symmetrically disposed at its central line. The first portion 203 of the calibrator 202 has the standard color (for example, the standard white color), and the second portion 205 has any other color excepting the standard color, for example, a gray color. The third portion has the black color, and the third portion doesn't influence the calibration result. Thus, the scanning range of the image sensor doesn't have to be controlled only in the first portion 203, but can capture data from the first portion 203 and the third portion 207 entirely (please refer to the first calibration data 301 in FIG. 5).

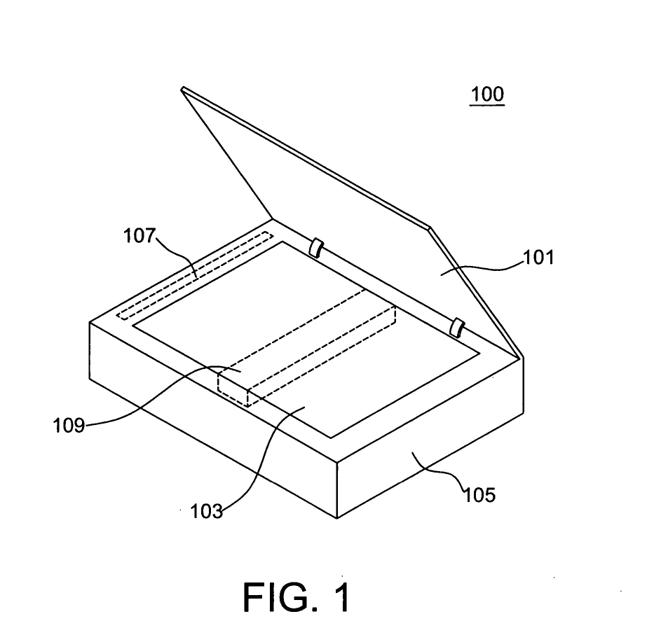

FIG. 5 is a schematic view illustrating the first stage of the calibration method of the present invention. The X-axis represents the relative position of the image scanning (i.e. the image sensor module moves along the X direction and scans images sequentially), and the Y-axis represents the calibration data from the image scanning. Referring to FIGS. 1 and 5, the image sensor module scans the calibrator 107 first during calibration. Referring to FIG. 5, the image sensor scans the first portion 203 to generate a first calibration data 301, and scans the second portion 205 to generate a second calibration data 303. Due to color difference between the first portion 203 and the second portion 205, the first calibration data 301 is distinct from the second calibration data 303.

FIG. 6 is a schematic view illustrating the second stage of the calibration method of the present invention. As shown in FIG. 6, the X-axis represents the relative position of the image scanning, and Y-axis represents the calibration data from the image scanning. As mentioned above, after obtaining the first calibration data 301 and the second calibration data 303, the image sensor module utilizes the first calibration data 301 to calibrate the second calibration data 303 to derive the third calibration data 305. When the image sensor module scans target objects (not only calibration), the image sensor module utilizes the third calibration data 305 to calibrate the data. The calibration method can be described as two formulas described below.

$$\begin{matrix}Wavg = {\sum }_{i = 1}^{M} Wi / M & ( a ) \\ Fj = ( \frac{Wavg}{G max} ) ⨯ Gj ( j = 1 , 2 , … N ) & ( b )\end{matrix}$$

Wavg: Average value of the standard color calibration data;
Wi: The standard color calibration data (the first calibration data 301) at the i-th reference point;
M: Number of the reference points in the first portion 203;
Gj: The non-standard color calibration data (the second calibration data 303) at the j-th reference point;
j: Number of the reference points in the second portion 205;
Gmax: The maximum of all the Gj;
Fj: The calibrated standard color calibration data (the third calibration data 305) at the j-th reference point.

In the above-mentioned Formula (a), the image sensor module averages the first calibration data 301 (Wi) from the first portion 203, and obtains an average value (Wavg). In the Formula (b), the maximum Gmax is retrieved from the second calibration data 303 (Gj) from the second portion 205, and then the third calibration data 305 (Fj) is calculated. The image sensor module utilizes the third calibration data 305 to calibrate the standard color (each reference point along X direction has its own the third calibration data 305), for example, a standard white color. The configuration of the first portion 203 and the second portion 205 in FIG. 3 only exemplify the relative position between the two portions, not intending to limit the present invention.

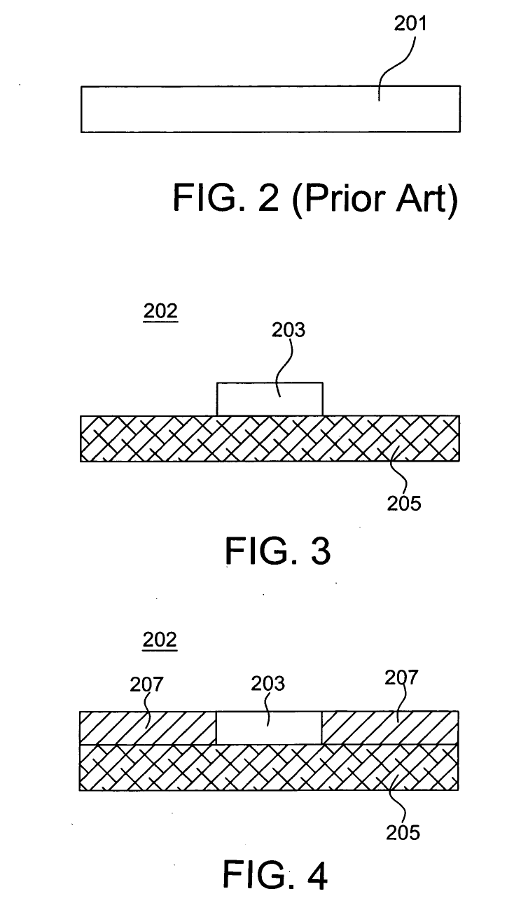

Please refer to FIGS. 2 and 3, the calibrator 202 of FIG. 3 has calibration function as well as the traditional calibrator 201 of FIG. 2. Considering the production cost, due to the high cost of a standard color calibrator (since quality requirement is relatively high), using the calibrator 202 can reduce the cost effectively. Further, the calibrator 202 has less probability of being polluted by deposited particles and dust. This is because the standard color portion (the first portion 203) of the calibrator 202 is relatively shorter than the traditional calibrator 201. Thus, the image capture apparatus including the calibrator 202 can facilitate the calibration in a cost-effective way.

The image calibration method of the present invention is for use with an image-capture apparatus. As shown in FIG. 1, the image-capture apparatus includes a window glass 103, an image sensor module disposed under the window glass 103, and a calibrator 107 disposed under the image sensor module. In accordance with the present invention, the calibrator 107 includes a first portion 203 and a second portion 205. The method includes at least: (1) the image sensor module scanning the first portion 203 to generate a first calibration data 301 and scanning the second portion 205 to generate a second calibration data 303 during a calibration process; (2) the image-capture apparatus utilizing the first calibration data 301 and the second calibration data 303 to obtain a third calibration data 305 for calibrating the image sensor module.

While the invention has been described in connection with what is presently considered to be the most practical and preferred embodiments, it is to be understood that the invention is not to be limited to these embodiments. The invention is intended to cover various modifications and equivalent arrangements within the spirit and scope of the appended claims.

We claim:

1. An image capture apparatus, comprising:
a window glass;
an image sensor module disposed under the window glass; and
a calibrator, the calibrator including a first portion and a second portion, the image sensor module scanning the first portion to generate a first calibration data and scanning the second portion to generate a second calibration data during a calibration process;
wherein the image-capture apparatus utilizes the first calibration data and the second calibration data to obtain a third calibration data for calibrating the image sensor module.

2. The apparatus according to claim 1, wherein length of the first portion is smaller than length of the second portion.

3. The apparatus according to claim 2, wherein the first portion is a standard calibrator with standard color.

4. The apparatus according to claim 3, wherein the standard calibrator is with standard white color.

5. The apparatus according to claim 3, wherein the second portion is a reference calibrator with reference color.

6. The apparatus according to claim 5, wherein the reference calibrator is with gray color.

7. The apparatus according to claim 1, wherein the first portion is aside of the second portion.

8. The apparatus according to claim 1, wherein a central line of the first portion substantially overlaps a central line of the second portion.

9. The apparatus according to claim 1, wherein the first calibration data is a part of a standard color calibration data.

10. The apparatus according to claim 7, wherein the second calibration data is a gray calibration data.

11. The apparatus according to claim 8, wherein the third calibration data is a standard color calibration data.

12. An image calibration method, for use with an image-capture apparatus, the image-capture apparatus including a window glass, an image sensor module disposed under the window glass, and a calibrator disposed above the image sensor module, the calibrator including a first portion and a second portion, the method comprising:
the image sensor module scanning the first portion to generate a first calibration data and scanning the second portion to generate a second calibration data during a calibration process;
the image-capture apparatus utilizing the first calibration data and the second calibration data to obtain a third calibration data for calibrating the image sensor module.

13. The method according to claim 12, wherein length of the first portion is smaller than length of the second portion.

14. The method according to claim 12, wherein the first portion is a standard calibrator with standard color.

15. The method according to claim 14, wherein the second portion is a calibrator with gray color.

16. The method according to claim 12, wherein the first portion is aside of the second portion.

17. The method according to claim 12, wherein a central line of the first portion substantially overlaps a central line of the second portion.

18. The method according to claim 12, wherein the first calibration data is a part of a standard color calibration data.

19. The method according to claim 18, wherein the second calibration data is a gray calibration data.

20. The method according to claim 12, wherein the third calibration data is a standard color calibration data.
